(19) United States
(12) Patent Application Publication
(10) Pub. No.: US 2020/0201308 A1
(43) Pub. Date: Jun. 25, 2020

(54) INDUSTRIAL PLANT MONITORING DEVICE AND DISTRIBUTED CONTROL SYSTEM

(71) Applicants: Kabushiki Kaisha Toshiba, Minato-ku (JP); Toshiba Infrastructure Systems & Solutions Corporation, Kawasaki-shi (JP)

(72) Inventor: Genki TATENO, Hino (JP)

(73) Assignees: Kabushiki Kaisha Toshiba, Minato-ku (JP); Toshiba Infrastructure Systems & Solutions Corporation, Kawasaki-shi (JP)

(21) Appl. No.: 16/643,090

(22) PCT Filed: Apr. 3, 2018
(86) PCT No.: PCT/JP2018/014238

§ 371 Date: Feb. 28, 2020

(30) Foreign Application Priority Data
Sep. 21, 2017 (JP) 2017-181519

(51) Int. Cl. G05B 23/02; G05B 19/042; G08B 21/18; G06F 16/901

(52) U.S. Cl. CPC G05B 23/0208; G06F 16/901; G08B 21/18; G05B 19/0428

(57) ABSTRACT

A plant monitoring device includes storage and one or more processors. The storage includes an alarm database in which a plurality of items of determination information as to alarm information is registrable, the alarm information being identification information for identifying an alarm. The processors are configured to register, in response to input of an item of determination information as to the alarm information, the item of determination information and the alarm information in the alarm database in association with each other.

### FIELD

Embodiments of the present invention relate generally to a plant monitoring device and a distributed control system.

### BACKGROUND

Conventionally, a controller is used for controlling input/output (I/O) devices in a distributed control system (DCS) that controls an industrial plant (hereinafter, simply referred to as a plant), for example. In order to allow an operator to monitor the execution of processing by such a controller, plant monitoring devices such as a human machine interface (HMI) are used.

When a malfunction occurs in a plant, for example, a plant monitoring device acquires alarm information indicating occurrence of the malfunction from a controller and displays the information on a display so as to allow an operator to recognize the alarm. Typically, each operator is assigned with one plant monitoring device to deal with the alarm by, for example, recovery, depending on details of the alarm displayed on the display.

### CITATION LIST

### Patent Literature

Patent Literature 1: Japanese Laid-open Patent Application Publication No. 2011-215832

Patent Literature 2: Japanese Laid-open Patent Application Publication No. 2013-182547

### SUMMARY OF THE INVENTION

### Problem to be Solved by the Invention

Conventionally, however, each operator's determinations on individual alarms are not shared among the other operators successively. This may make it difficult for two or more operators to work on a task in cooperation if a large number of alarms occur.

### Means for Solving Problem

According to one embodiment, in general, a plant monitoring device includes storage and a register. The storage includes an alarm database that contains alarm information, first determination information, and second determination information in association with one another, the alarm information being identification information for identifying an alarm, the first determination information representing a determination of an operator about the alarm information, the determination being inputted to the plant monitoring device, the second determination information representing a determination of another operator about the alarm information, the determination being inputted to another plant monitoring device. The register is configured to register, in response to input of the first determination information about the alarm information, the first determination information and the alarm information in the alarm database in association with each other, and to register, in response to receipt of the second determination information about the alarm information, the second determination information and the alarm information in the alarm database in association with each other.

### BRIEF DESCRIPTION OF DRAWINGS

FIG. 1 is a diagram illustrating an exemplary overall configuration of a distributed control system in accordance with a first embodiment;

FIG. 2 is a diagram illustrating exemplary functional configurations of human machine interfaces (HMIs) and a controller in accordance with the first embodiment;

FIG. 3 is a diagram illustrating an exemplary configuration of tasks executed by the controller in accordance with the first embodiment;

FIG. 4 is a chart illustrating an exemplary data configuration of an alarm database in accordance with the first embodiment;

FIG. 5 is a chart illustrating an exemplary data configuration of a determination database in accordance with the first embodiment;

FIG. 6 is a flowchart illustrating exemplary plant monitoring processing executed by the HMIs in accordance with the first embodiment;

FIG. 7 is a diagram illustrating exemplary functional configurations of HMIs and a controller in accordance with a second embodiment;

FIG. 8 is a chart illustrating an exemplary data configuration of a determination database in accordance with the second embodiment;

FIG. 9 is a flowchart illustrating exemplary plant monitoring processing executed by the HMIs in accordance with the second embodiment;

FIG. 10 is a diagram illustrating exemplary functional configurations of HMIs and a controller in accordance with a third embodiment;

FIG. 11 is a chart illustrating an exemplary data configuration of a determination history database in accordance with the third embodiment; and

FIG. 12 is a flowchart illustrating exemplary plant monitoring processing executed by the HMIs in accordance with the third embodiment.

### DETAILED DESCRIPTION

### First Embodiment

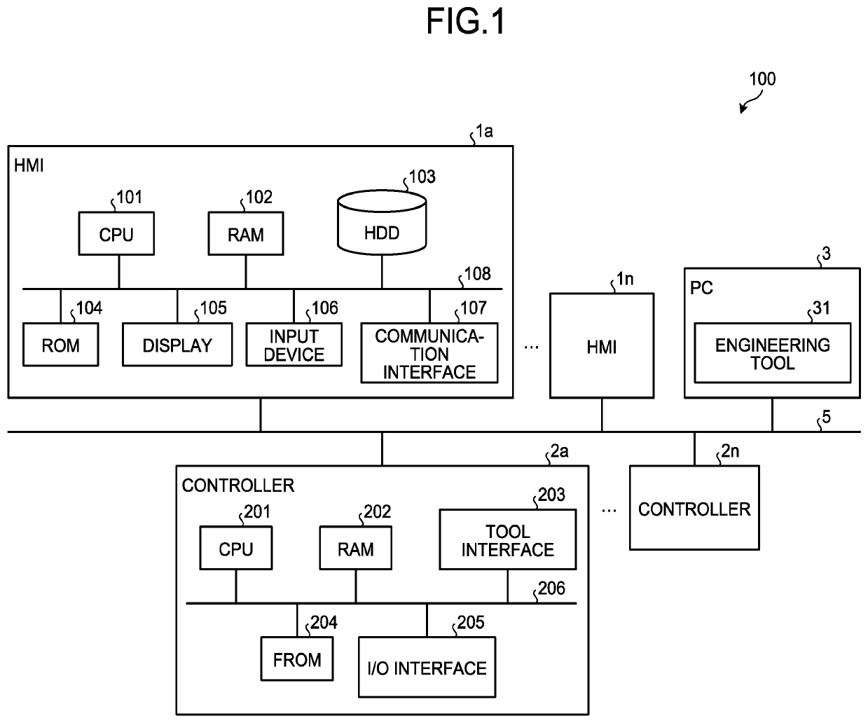

FIG. 1 is a diagram illustrating an exemplary overall configuration of a distributed control system 100 in accordance with a first embodiment. As illustrated in FIG. 1, the distributed control system 100 includes controllers 2a to 2n, human machine interfaces (HMIs) 1a to 1n, a personal computer (PC) 3 as an engineering tool. The controllers 2a to 2n, the HMIs 1a to 1n, and the engineering tool PC 3 are communicably connected to one another via a local area network (LAN) 5.

The controllers 2a to 2n are controllers for the distributed control system (DCS) 100. More specifically, to control a plant, the controllers 2a to 2n calculate various kinds of information inputted from sensors in the plant and provide output information to controlled devices such as a valve. One distributed control system 100 typically includes controllers 2a to 2n. The present embodiment is not intended to particularly limit the number of the controllers 2a to 2n. Hereinafter, the controllers 2a to 2n will be simply referred to as controllers 2 unless otherwise distinguished.

Each of the controllers 2 serves as a computer that includes a central processing unit (CPU) 201, a random access memory (RAM) 202, a tool interface 203, a flash read only memory (FROM) 204, an input/output (I/O) interface 205, and a bus 206. The hardware configuration of the controllers 2 illustrated in FIG. 1 is merely exemplary and not intended to limit the hardware configuration.

The tool interface 203 is an interface for transmitting and receiving information to and from the other controllers 2, the HMIs 1a to 1n, and the engineering tool PC 3.

The I/O interface 205 is an interface for transmitting and receiving information to and from controlled devices and various kinds of sensors, for example.

The HMIs 1a to 1n are devices for use by the operators to monitor the progress of processing executed by the controllers 2. One distributed control system 100 typically includes two or more HMIs 1a to 1n. In the present embodiment, each operator is assigned with one HMI among the HMIs 1a to 1n, however, the number of HMIs 1 is not limited thereto. Hereinafter, the HMIs 1a to 1n will be simply referred to the HMIs 1 unless otherwise particularly distinguished. Each of the HMIs 1 transmits information inputted by the operator to the other HMIs 1, and receives information inputted by the other operators from the other HMIs 1, thereby sharing (synchronizing) the information among the HMIs 1. The information that the operators input to the HMIs 1 will be described in detail later. The HMIs 1 are exemplary plant monitoring devices in the present embodiment.

Each of the HMIs 1 includes a CPU 101, a RAM 102, a hard disk drive (HDD) 103, a ready only memory (ROM) 104, a display 105, an input device 106 such as a mouse or a keyboard, a communication interface 107, and a bus 108. Each HMI 1 may be, for example, a personal computer (PC) with a general hardware configuration.

The communication interface 107 serves as an interface for transmitting and receiving information to and from the other HMIs 1, the controller 2, and the engineering tool PC 3.

The engineering tool PC 3 (hereinafter, referred to as the PC 3) represents a computer including an engineering tool 31. As with the HMIs 1, the PC 3 has a general computer hardware configuration.

The engineering tool 31 serves as computer software which enables generation of a control program and a task to be executed by the controllers 2 and setting of a parameter value for use in the control program. The engineering tool 31 is operated by an engineer being a user of the PC 3, to generate a computer program, for example. By downloading the computer program generated by the engineering tool 31 onto the controllers 2 through the LAN 5, the controllers 2 can execute processing to control the plant. The control program executed by the controllers 2 will be described later.

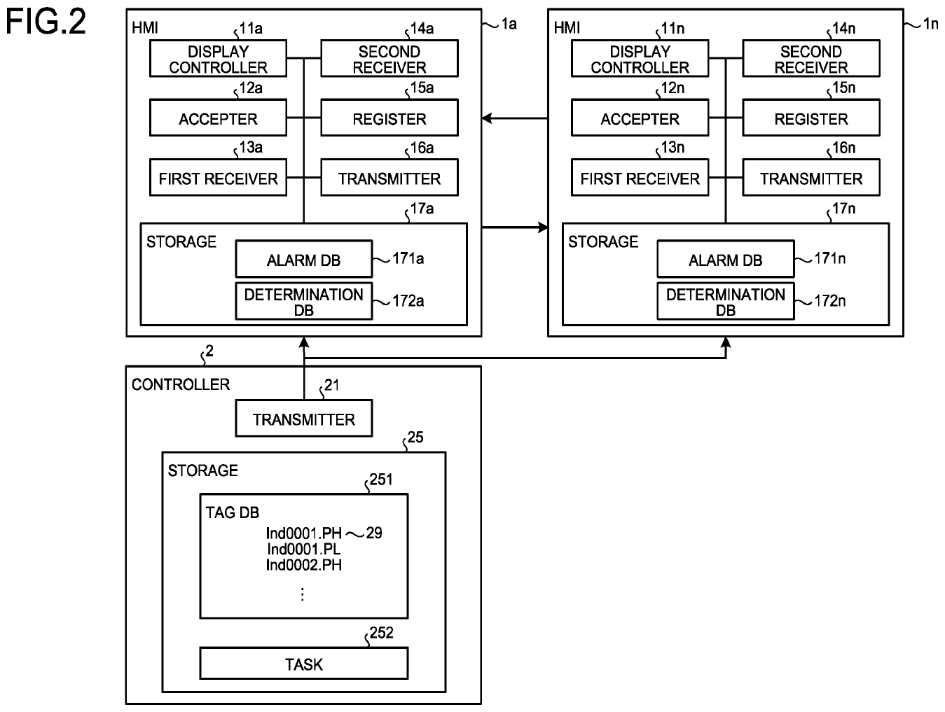

FIG. 2 is a diagram illustrating exemplary functional configurations of the HMIs 1 and the controller 2 in accordance with the first embodiment.

Each of the controllers 2 includes a storage 25 and a transmitter 21.

The storage 25 stores therein a tag database (DB) 251 and a task 252. The storage 25 includes, for example, the FROM 204.

The task 252 includes two or more control programs for each function and serves as execution unit of operation by the controllers 2. The storage 25 typically stores therein multiple tasks 252. Each of the tasks 252 includes one or two or more program organization units (POUs). POU refers to a control program generated by modularizing each function. The tasks 252 and the POUs of the tasks 252 are generated by the engineering tool 31, and are downloaded onto the controllers 2. The tasks 252 and the POUs will be described in detail later.

The tag database 251 stores therein tag data for use in operations to be executed by the controllers 2. Tag data represents a parameter group including two or more parameter values associated with each of the POUs. More specifically, tag data contains a tag name that indicates an intended operation (POU) and a parameter value associated with the tag name. For example, tag data 29 with a tag name “Ind0001” includes, as a parameter value, “PH” indicating a kind of an alarm occurring in the operation concerned. “PH” represents an alarm indicating that a process value (PV) of a monitored sensor exceeds an upper-limit value. The parameter value included in the tag data 29 is not limited to a kind of alarm. For example, the tag data 29 may further contain a parameter value for use in a function block of the POU, a threshold for determining occurrence of an alarm, and a parameter value indicating the importance (grade) of an alarm having occurred. When the process value of a sensor returns to a normal range, recovering (ending) the alarm, for instance, the information indicating the kind of the alarm is deleted from the tag data 29.

The transmitter 21 reads, out of the tag data stored in the tag database 251, tag data with the kind of an alarm set, and transmits, to the HMIs 1, a tag name of the tag data and the kind of the alarm associated with the tag name. In the present embodiment, among the parameters contained in tag data, information indicating a tag name and the kind of an alarm associated with the tag name is defined as alarm information being identification information of an alarm. Upon recovery of an alarm, the transmitter 21 transmits alarm recovery information for identifying the recovered alarm to the HMIs 1.

The HMI 1a includes a display controller 11a, an accepter 12a, a first receiver 13a, a second receiver 14a, a register 15a, a transmitter 16a, and a storage 17a.

As with the HMI 1a, the HMI 1n includes a display controller 11n, an accepter 12n, a first receiver 13n, a second receiver 14n, a register 15n, a transmitter 16n, and a storage 17n. The HMIs 1 have the same functions, therefore, these functions will be simply referred to as display controller 11, accepter 12, first receiver 13, second receiver 14, register 15, transmitter 16, and storage 17, unless which of the HMIs 1 the functions belong to needs to be specified.

The storage 17 includes an alarm database (DB) 171 (171a, 171n) and a determination database (DB) 172 (172a, 172n). The storage 17 is made up of, for example, the HDD 103.

The alarm database 171 contains alarm information, first determination information representing an operator's determination about the alarm information, inputted to the corresponding HMI, and second determination information representing other operators' determinations about the same alarm information, inputted to the other HMIs 1, in association with one another.

The first determination information and the second determination information serve as identification information for identifying details of a determination of each operator and are defined as determination numbers (numerals) in the present embodiment. In other words, the alarm database 171 is a database in which alarm information and the numbers of determinations of each operator about the alarm information are registered. The first determination information and the second determination information are not limited to numbers, and may be, for example, character strings such as a code, or text.

In the present embodiment, the determinations of the individual operators to be registered in the alarm database 171 include not only final determinations on each alarm but also primary determinations made when each operator has found an alarm. Depending on variation in situation, the registered determination numbers in the alarm database 171 may be updated by the operators. The alarm database 171 will be described in detail later.

The determination database 172 contains common determination information representing the first determination information or the second determination information, detail information representing the details of the common determination information, and a display mode, in association with one another. In the present embodiment, the common determination information represents determination numbers, as with the first and second determination information. In other words, the registered information in the determination database 172 is master data associated with determination numbers registered in the alarm database 171.

Detail information represents an operator's determination on alarm information or a status of a response to an alarm in a detailed manner sufficient to allow the other operators to understand them.

The display mode represents information indicating a display mode in which the first determination information or the second determination information is to be displayed on the display 105. The determination database 172 will be described in detail later.

In the present embodiment, data is registered in advance in the determination database 172. The operator selects, from among the registered determination numbers in the determination database 172, a determination number matching his or her determination and sets (inputs) the determination number for alarm information. Operators' inputs of the determination numbers will be described later.

The display controller 11 displays, on the display 105, in a display mode corresponding to the determination number of each operator, the alarm information registered in the alarm database 171, and the detail information registered in the determination database 172 and associated with the determination number corresponding to the alarm information. The display controller 11 displays the detail information associated with the determination number, which makes the other operators more easily understand the determination of each operator than direct display of the determination numbers.

The display controller 11 may separately display a screen of the alarm information and a screen of the detail information associated with the determination number of each alarm information, or may display the alarm information and the detail information on the same screen.

The display controller 11 displays an input screen for a determination number of each alarm information on the display 105. In this case, the display controller 11 displays, on the display 105, the determination numbers and the detail information registered in the determination database 172 in such a manner that the operators can make a selection.

In the present embodiment, the display controller 11 displays the screens at timing at which the alarm database 171 is updated. The display timing is not limited thereto. For example, the display controller 11 may read the alarm database 171 and the determination database 172 at certain time intervals to display alarm information and detail information.

The accepter 12 accepts an inputted determination number for alarm information. More specifically, the accepter 12 accepts a determination number of alarm information inputted by the operator on the input screen displayed on the display 105.

The first receiver 13 receives alarm information and alarm recovery information from the controller 2. The first receiver 13 registers (adds) the received alarm information in the alarm database 171. Before registering the received alarm information in the alarm database 171, the first receiver 13 may search the alarm database 171 for the alarm information concerned and register the alarm information in the alarm database 171 if the alarm information is not registered yet. Checking redundant data before the registration makes it possible to prevent unnecessary overwrite of the same data.

Upon receiving alarm recovery information, the first receiver 13 deletes alarm information corresponding to the alarm recovery information and the determination number associated with the alarm information from the alarm database 171.

The second receiver 14 receives, from another HMI (for example, the HMI 1n) of the distributed control system 100, alarm information and the determination number of the alarm information inputted to another HMI 1 by another operator.

In response to input of first determination information about alarm information, the register 15 registers the first determination information in the alarm database 171 in association with the alarm information. In response to a receipt of second determination information about alarm information, the register 15 registers the second determination information in the alarm database 171 in association with the alarm information. More specifically, when the accepter 12 accepts an inputted determination number of any alarm information from the operator of the corresponding HMI, the register 15 registers the determination number in the alarm database 171 in association with the alarm information and the identification information of the operator. When the second receiver 14 receives alarm information and a determination number associated with the alarm information from another HMI 1, the register 15 registers the determination number in the alarm database 171 in association with the alarm information and the identification information of the operator being the user of another HMI 1.

The transmitters 16 transmits, to another HMI 1, a determination number inputted to the corresponding HMI by the operator and alarm information associated with the determination number, among the data registered in the alarm database 171. For example, the transmitter 16a of the HMI 1a transmits a determination number inputted by an operator A and alarm information associated with the determination number to the HMI 1n.

In the present embodiment, the transmitter 16 transmits the determination number to another HMI 1 if the inputted determination number is registered in the alarm database 171, but the transmission timing of the transmitter 16 is not limited thereto. For example, the transmitter 16 may perform the transmission to another HMI 1 at certain time intervals. For the transmission at certain time intervals, the transmitter 16 regards, as subjects of transmission, a determination number of the operator of the corresponding HMI and alarm information associated with the determination number which have been registered in the alarm database 171 or updated after a previous transmission. Alternatively, the transmitter 16 may regard, among the data registered in the alarm database 171, all the data associated with the operator using the corresponding HMI as subjects of transmission. The transmitter 16 may transmit a determination number requested by another HMI 1 and alarm information associated with the requested determination number.

The following describes the details of the tasks 252 and the POUs executed by the above controller 2.

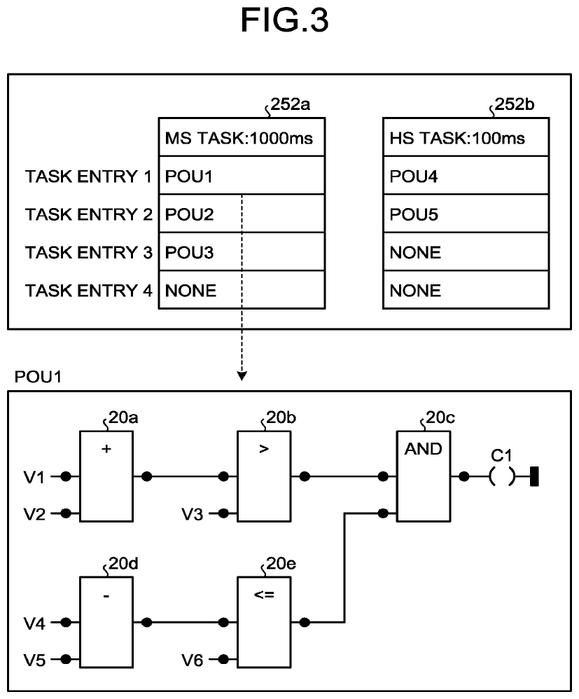

FIG. 3 is a diagram illustrating exemplary configurations of the tasks 252 executed by the controller 2 of the present embodiment. FIG. 3 illustrates, as an example, a task 252a being a main scan task (MS task) having a longer maximum allowable execution time and a task 252b being a high-speed scan task (HS task) having a shorter maximum allowable execution time.

The task 252a is a main scan task (MS task) having a longer maximum allowable execution time. The POU1 to POU3, of the task 252a, are control programs being modules of the respective functions, and are set to task entries 1 to 3 in order of execution. For example, the POU1 is a control program including function blocks 20a to 20e (hereinafter, referred to as function blocks 20).

Parameter values for use in the operation of each function block 20 of the POU1 to POU3 are included in tag data stored in the tag database 251.

Each of the tasks 252 is executed in a scan cycle. For example, the scan cycle of the task 252a is set to 1,000 ms, and the task 252a executes the POU1 to POU3 in every 1,000 ms. The POU1 to POU3 are typically required to end operations before a next scan cycle starts, so that the scan cycle is set to the maximum allowable execution time of the entire task 252a.

The following describes the details of the above alarm database 171.

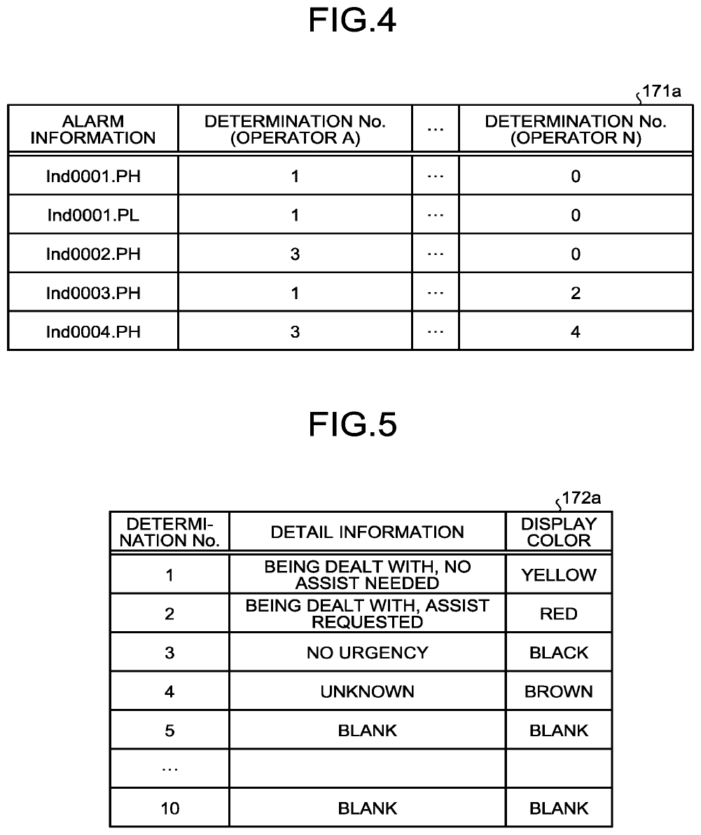

FIG. 4 is a chart illustrating an exemplary data configuration of the alarm database 171a of the present embodiment. As illustrated in FIG. 4, the alarm database 171a stores alarm information, determination numbers of the alarm information inputted to the HMI 1a by the operator A, and determination numbers of the alarm information inputted by an operator N to another HMI 1, for example, the HMI 1n, in association with one another. The determination numbers of the operator A in the alarm database 171a represent exemplary first determination information in the present embodiment, and the determination numbers of the operator N in the alarm database 171a represent exemplary second determination information in the present embodiment.

The alarm database 171 of the present embodiment includes a determination-number item (column) for each of the operators, however, the configuration of the alarm database 171 is not limited thereto. The alarm database 171 may include, for example, an identification-information item for identifying the operators.

After the HMI 1a and the HMI 1n exchange the determination numbers of the operators and the alarm information associated with the determination numbers, the data registered in the alarm database 171a and the data registered in the alarm database 171b match each other.

The following describes the above determination database 172 in detail.

FIG. 5 is a chart illustrating an exemplary data configuration of the determination database 172a in accordance with the present embodiment. The determination database 172a stores determination numbers, detail information, and colors of display in association with one another.

The detail information may represent a determination made by the operator about alarm information or the status of a response to an alarm in a detailed manner sufficient to be understandable to the other operators. It is exemplified by short phrases such as “BEING DEALT WITH, NO ASSIST NEEDED”.

Color of display represents an exemplary display mode such as colors of icons and font for display on the display 105. Colors of display are set depending on levels of urgency or importance. A display mode is not limited to color of display, and may be other kinds of information such as color shading and flickering (blinking) intervals.

Herein, the data corresponding to the columns of the determination database 172, i.e., determination number, detail information, and color of display is referred to as determination data. In the present embodiment, the same data is pre-registered in the respective determination databases 172 of the HMIs 1, thus, the same determination data is registered in the determination database 172n and in the determination database 172a.

The configuration and contents of registered detail information in the determination database 172 of the present embodiment are merely exemplary, and are not limited to such an example.

The following describes plant monitoring processing by the above-configured HMIs 1 of the present embodiment.

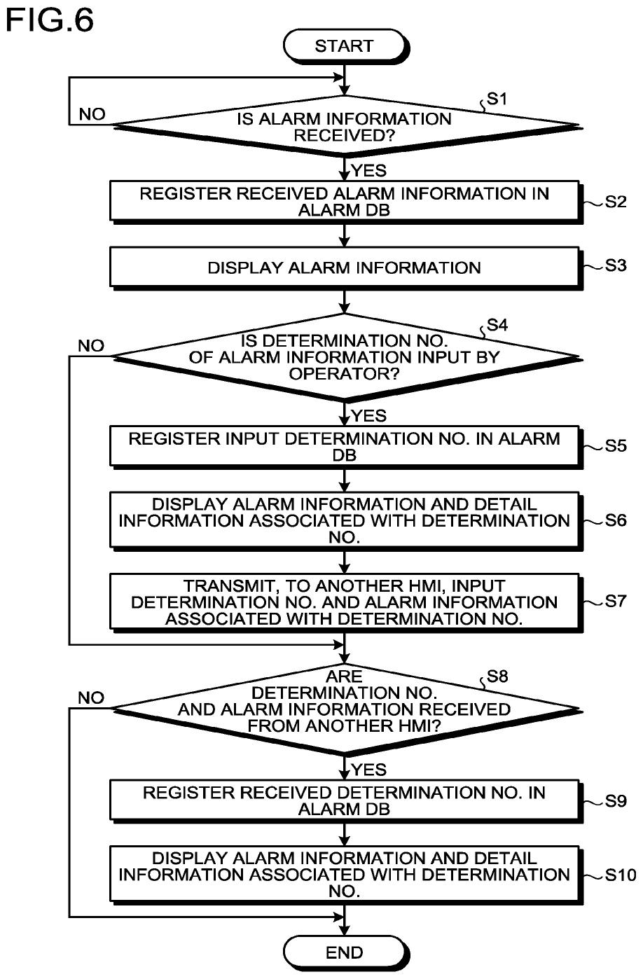

FIG. 6 is a flowchart illustrating exemplary plant monitoring processing executed by the HMI 1 of the present embodiment.

In response to receipt of alarm information from the controller 2 (“Yes” at S1), the first receiver 13 of the HMI 1 registers the received alarm information in the alarm database 171 (S2). Upon receipt of no alarm information (“No” at S1), the first receiver 13 repeats the operation at S1 and stands by.

The display controller 11 displays, on the display 105, the alarm information registered in the alarm database 171 (S3).

When the accepter 12 accepts an inputted determination number for the displayed alarm information from the operator (“Yes” at S4), the register 15 registers the inputted determination number in the alarm database 171 in association with the alarm information (S5).

The display controller 11 reads the registered alarm information and determination number from the alarm database 171. The display controller 11 also reads detail information and a display color associated with the determination number from the determination database 172. The display controller 11 displays, on the display 105, the read alarm information and the detail information associated with the determination number of the alarm information, in font color (or icon of registered color) associated with the determination number of the alarm information (S6). At this point, the detail information associated with the determination number inputted by the operator of the corresponding HMI is displayed.

The transmitter 16 transmits, among the data registered in the alarm database 171, the determination number inputted by the operator and the alarm information associated with the determination number to another HMI 1 (S7).

When the second receiver 14 receives, from another HMI 1, a determination number inputted by another operator to another HMI 1 and alarm information associated with the inputted determination number (“Yes” at S8), the register 15 registers the received determination number of another operator and the received alarm information in the alarm database 171 in association with each other (S9).

The display controller 11 displays the alarm information and the detail information associated with the determination number of the alarm information in font color corresponding to the determination number of the alarm information (S10). In this case, the display controller 11 displays the detail information associated with the determination number inputted by another operator to another HMI 1, in addition to the detail information associated with the determination number inputted by the operator to the corresponding HMI.

When the accepter 12 accepts no inputted determination number of alarm information (“No” at S4), the operations at S5 to S7 are not executed and the process proceeds to S8. Further, when the second receiver 14 receives no determination number or no alarm information from another HMI 1 (“No” at S8), the operations at S9 and S10 are not executed, ending the processing of this flowchart.

At the time of S3, if a determination number has been already registered for any alarm information in the alarm database 171, the display controller 11 may display the alarm information and the detail information.

Conventionally, with occurrence of a large number of alarms in a plant, for example, two or more operators may attempt to deal with the alarms through work sharing. It is, however, difficult for the operators to successively share the decisions made by the other operators and a status of a response to each alarm. The operators may be able to collect the information on the determinations made by the other operators about the alarms through verbal communication. However, it may be difficult for the operators to frequently communicate verbally under the situation that a large number of alarms is occurring, and to know the latest determinations of the other operators. Thus, it may be conventionally difficult for the operators to work on the task in cooperation.

By contrast, the HMI 1 of the present embodiment registers, in the alarm database 171, the alarm information, determination numbers of the alarm information inputted to itself, and the determination numbers of the alarm information inputted to the other HMIs 1. Thus, the HMI 1 can notify its operators of the other operators' determinations. Because of this, the HMIs 1 of the present embodiment can facilitate two or more operators to work on the task in cooperation without information sharing through verbal communication.

According to the present embodiment, not the controllers 2 but each of the HMIs 1 is equipped with the alarm database 171. Thus, the HMIs 1 can share the operators' determinations on each alarm without change in the configuration of the controllers 2.

The HMI 1 of the present embodiment performs display on the display 105 in the display mode registered in the determination database 172, which enables each operator to easily recognize urgency levels of the other operators' determinations about each alarm on the screen. The HMI 1 also displays detail information, stored in the determination database 172, on the display 105. This makes it possible for each operator to know the other operators' determinations in detail.

In the present embodiment each operator uses one HMI 1. However, two or more operators may use one HMI 1 together. In this case, by receiving, for example, a user identification (ID) for identifying each operator together with a determination number, the HMI 1 may identify the determination number that the operator has input.

The present embodiment has adopted the two databases, i.e., the alarm database 171 and the determination database 172, however, it may adopt a single database containing the data in both the alarm database 171 and the determination database 172. In addition, the detail information may be registered in the alarm database 171 as the first determination information and the second determination information in place of the determination numbers.

According to the present embodiment, the first receiver 13 receives and registers the alarm information in the alarm database 171. However, the register 15 may register the alarm information received by the first receiver 13 in the alarm database 171.

According to the present embodiment, the alarm information represents a tag name corresponding to an operation in which an alarm occurs, and a kind of the alarm associated with the tag name. However, the alarm information is not limited thereto. For example, the alarm information may additionally include information on level of importance of an alarm.

### Second Embodiment

In the first embodiment each operator selects detail information or color of display suitable for his or her determination from the ones pre-registered in the determination database and sets the selected detail information and color of display to the respective items of alarm information. In a second embodiment, the operators are allowed to register detail information and color of display in the determination database, so that the operators can more suitably share their determinations depending on a situation.

The overall configuration of a distributed control system 100 in the present embodiment is the same as that in the first embodiment illustrated in FIG. 1.

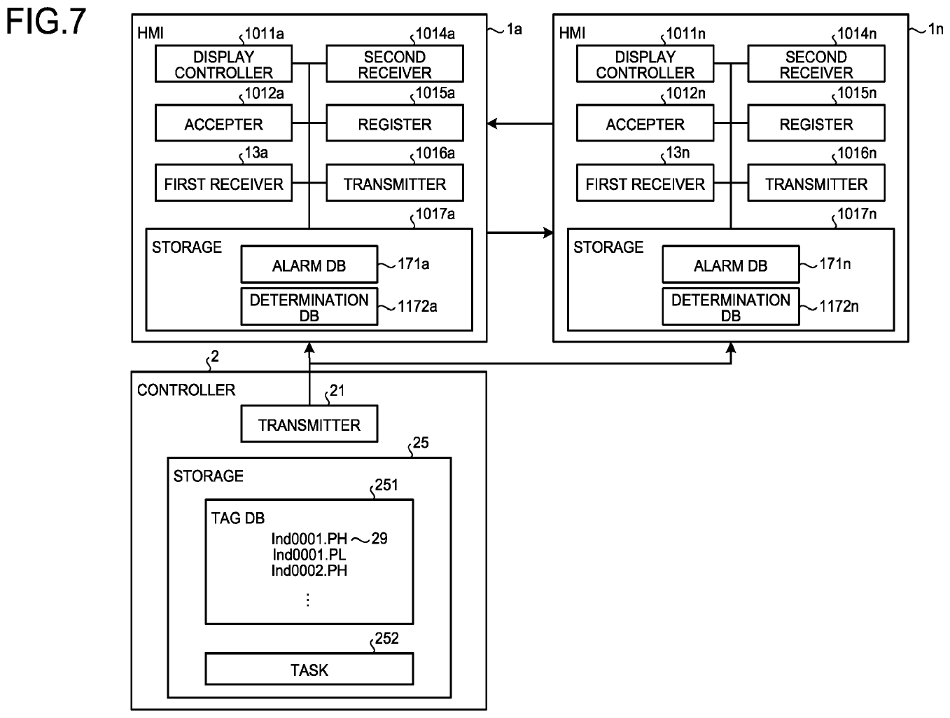

FIG. 7 is a diagram illustrating exemplary functional configurations of HMIs 1 and a controller 2 in accordance with the present embodiment.

As in the first embodiment, the controller 2 in the present embodiment includes a storage 25 and a transmitter 21. The functions of the storage 25 and the transmitter 21 are the same as those in the first embodiment.

Each of the HMIs 1 in the present embodiment includes a display controller 1011, an accepter 1012, a first receiver 13, a second receiver 1014, a register 1015, a transmitter 1016, and a storage 1017.

The first receiver 13 has the same function as that in the first embodiment.

The storage 1017 includes an alarm database 171 and a determination database 1172. The alarm database 171 is the same as that in the first embodiment.

As with the first embodiment, the determination database 1172 includes master data in which determination number, detail information, and color of display are associated with one another. In the present embodiment, the determination database 1172 additionally includes determination numbers pre-registered for common use by all the operators, and determination numbers to be added by the respective operators. The determination database 1172 in the present embodiment will be described in detail later.

In addition to the functions of the first embodiment, the display controller 1011 in the present embodiment displays, on the display 105, a determination-data input screen onto which determination data (determination number, detail information, and color of display) can be input. In response to an operator's operation for displaying the determination-data input screen, for example, the display controller 1011 displays the determination-data input screen. The display controller 1011 may display the determination-data input screen as a separate screen, or may allow input of determination data to the screen for displaying alarm information and detail information associated with the determination number of the alarm information.

In addition to the functions of the first embodiment, the accepter 1012 in the present embodiment accepts determination data inputted by the operator. The accepter 1012 permits each operator to input determination data only for the determination numbers that each operator can input. More specifically, in order to prevent overlaps of determination numbers among the operators, the determination numbers registerable by each operator are pre-defined. The determination data may be any data as long as it is unique, and a method other than limiting input of determination numbers may be adopted.

In addition to the functions of the first embodiment, the second receiver 1014 in the present embodiment receives, from another HMI 1 of the distributed control system 100, determination data inputted by another operator to another HMI 1.

In addition to the functions of the first embodiment, when the accepter 1012 accepts inputted determination data, the register 1015 of the present embodiment registers the inputted determination data in the determination database 1172. Further, when the second receiver 1014 receives determination data added by another operator from another HMI 1, the register 1015 registers the received determination data in the determination database 1172.

In the present embodiment, the operators are permitted to add determination data to the determination databases 1172 only, and they are not allowed to delete and overwrite determination data.

In addition to the functions of the first embodiment, the transmitter 1016 in the present embodiment transmits, to another HMI 1 of the distributed control system 100, the determination data inputted to the corresponding HMI by the operator among the determination data registered in the determination database 1172.

In the present embodiment, in response to a registration of inputted determination data in the determination database 1172, the transmitter 1016 transmits the determination data to another HMI 1. However, the timing when the transmitter 1016 transmits the determination data is not limited thereto. For example, the transmitter 1016 may transmit the determination data to another HMI 1 at certain time intervals. For the transmission at certain time intervals, the transmitter 1016 may regard, as subjects of transmission, determination data inputted after a previous transmission or all the determination data associated with the determination numbers addable by the operator of the corresponding HMI.

The following more specifically describes the determination database 1172 in the present embodiment.

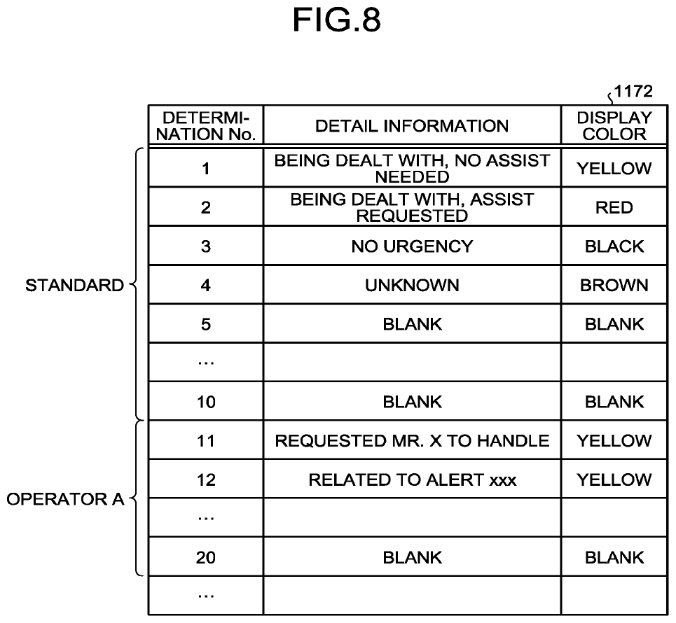

FIG. 8 is a chart illustrating an exemplary data configuration of the determination database 1172 in accordance with the present embodiment. The determination numbers “1” to “10” are standard determination numbers and data associated with the numbers is pre-registered as initial settings in the determination database 1172. The standard determination numbers are commonly used by all the operators.

Meanwhile, as to the determination numbers “11” to “20”, each operator can register detail information and color of display. In the present embodiment, the determination numbers that each operator can register are pre-defined. For example, the determination numbers “11” to “20” are registerable by the operator A.

In the present embodiment, each operator can add determination data to the determination database 1172, which enables adoption of detail information and a color of display more suitable for a situation.

The following describes plant monitoring processing by the above-configured HMIs 1 of the present embodiment.

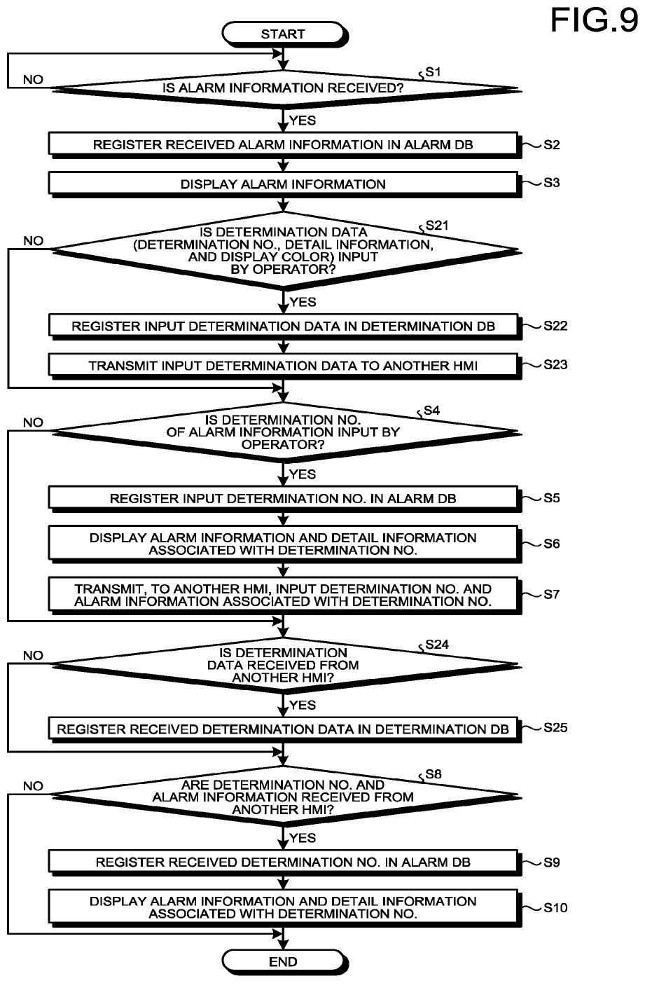

FIG. 9 is a flowchart illustrating exemplary plant monitoring processing executed by the HMI 1 of the present embodiment. The operation from reception of alarm information at S1 to display of the alarm information at S3 is the same as that in the first embodiment.

In the present embodiment, the operator can register new determination data. For example, having made a decision about the alarm information displayed at S3, not found in the detail information associated with the standard determination numbers, the operator registers new determination data.

When the accepter 1012 accepts determination data (determination number, detail information, and color of display) inputted by the operator (“Yes” at S21), the register 1015 registers the inputted determination data in the determination database 1172 (S22).

The transmitter 1016 transmits the determination data inputted by the operator to another HMI 1, among the determination data registered in the determination database 1172 (S23). With no determination data inputted by the operator (“No” at S21), the operations at S22 and S23 are not executed, and the process proceeds to S4.

At S4 to input a determination number for the alarm information, the operator can input the determination number inputted at S21. The operation from the registration of the determination number at S5 to the transmission of the determination number and the alarm information at S7 is the same as that of the first embodiment. When the accepter 1012 accepts no inputted determination numbers for the alarm information (“No” at S4), the operations at S5 to S7 are not executed and the process proceeds to S24.

When the second receiver 1014 receives, from another HMI 1, determination data inputted by another operator to another HMI 1 (“Yes” at S24), the register 1015 registers the received determination data in the determination database 1172 (S25).

When the second receiver 1014 receives, from another HMI 1, no determination data inputted by another operator to another HMI 1 (“No” at S24), the operation at S25 is not executed, and the process proceeds to S8. The operation from the reception of the determination number and the alarm information from another HMI 1 at S8 to the display of the alarm information and the detail information at S10 is the same as that in the first embodiment.

As described above, the HMIs 1 in the present embodiment register both the determination data inputted to themselves and the determination data received from the other HMIs 1 in the determination database 1172. Because of this, the HMIs 1 can share the operators' determinations through detail information more suitable for the situation, in addition to the effects of the first embodiment.

For example, it may be difficult to pre-register detail information representing specific determinations and situations including proper names. In the present embodiment, the operators can register determination data when appropriate, therefore, they can register more specific detail information in line with the alarm information.

In the present embodiment, the operators can only add determination data to the determination database 1172. However, deletion or overwriting by the operators may be accepted. Alternatively, the operators may be assigned with authority depending on their attributes (manager, person in charge with no title, etc.), and their executable operations (addition, deletion, and overwriting) to the determination database 1172 may be defined in accordance with the assigned authority. The upper limit number of items of determination data addable to the determination database 1172 may be changed depending on the attributes of the operators.

### Third Embodiment

In the first embodiment, each HMI 1 stores the latest determination numbers of the alarm information inputted by the operator in the alarm database 171. In a third embodiment, the HMI 1 further stores a history of determination numbers that the operator has inputted with respect to alarm information.

The overall configuration of the distributed control system 100 in the present embodiment is the same as that in the first embodiment illustrated in FIG. 1.

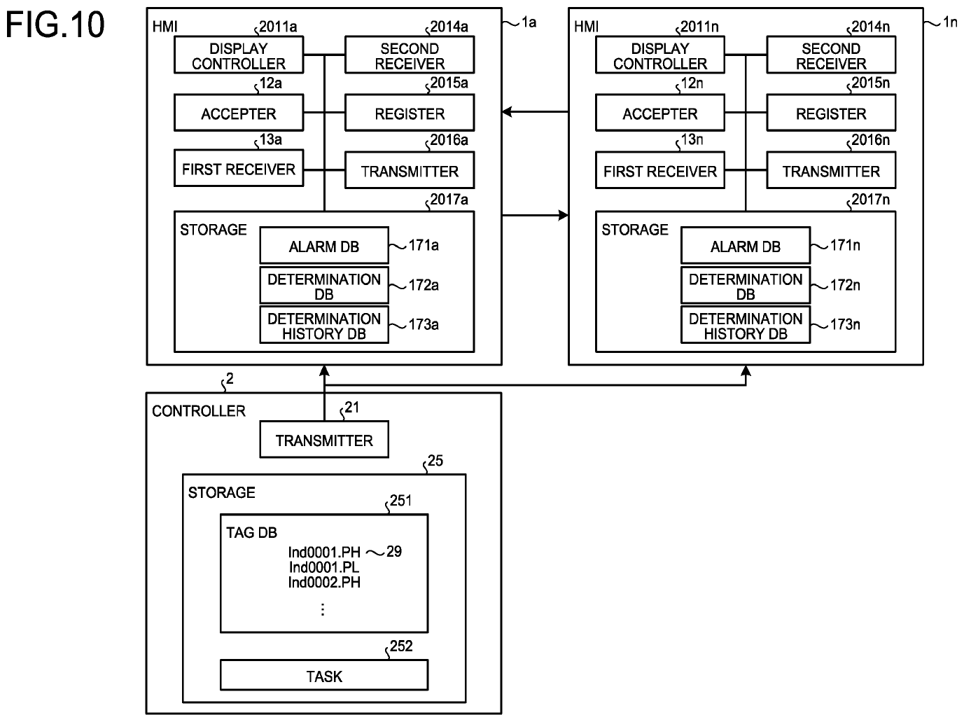

FIG. 10 is a diagram illustrating an exemplary functional configuration of the HMIs 1 and the controller 2 in accordance with the present embodiment.

As in the first embodiment, the controller 2 in the present embodiment includes a storage 25 and a transmitter 21. The functions of the storage 25 and the transmitter 21 are the same as those in the first embodiment.

Each of the HMIs 1 in the present embodiment includes a display controller 2011, an accepter 12, a first receiver 13, a second receiver 2014, a register 2015, a transmitter 2016, and a storage 2017.

The accepter 12 and the first receiver 13 have the same functions as those in the first embodiment.

The storage 2017 includes an alarm database 171, a determination database 172, and a determination history database (DB) 173 (173a and 173b). The alarm database 171 and the determination database 172 are the same as those in the first embodiment.

The determination history database 173 is a database in which change histories of each operator's determinations about each item of alarm information are registered in chronological order. Specifically, the determination history database 173 has registered therein determination numbers, time at which determination numbers have been inputted, and alarm information indicating alarms of interest, in association with one another. The determination history database 173 will be described in detail later. In the present embodiment, a change history of determination numbers inputted by each operator is referred to as a determination history.

In addition to the functions of the first embodiment, the display controller 2011 in the present embodiment displays, on the display 105, a determination history of which each operator has made on alarm information. The display controller 2011 may display the determination history on a separate screen or on the same screen as the alarm information.

The display controller 2011 displays the determination history at timing after a determination number is input and after a determination history is received from another HMI. However, the timing is not limited thereto. On the initial screen, for example, the display controller 2011 may display detail information associated with the latest determination number of each operator about each item of alarm information, and may display a determination history of each operator in response to his or her request for the display of a determination history.

In addition to the functions of the first embodiment, the second receiver 2014 in the present embodiment receives, from another HMI 1 of the distributed control system 100, a change history of determination numbers inputted by another operator to another HMI 1 (inputted determination numbers, alarm information associated with the determination numbers, and time at which the determination numbers have been inputted).

In addition to the functions of the first embodiment, when the accepter 12 accepts an inputted determination number, the register 2015 in the present embodiment registers time at which the input has been accepted, alarm information of interest, and the determination number in the determination history database 173 in association with one another. The register 2015 stores, in the storage 2017, the determination history of another operator received by the second receiver 2014 from another HMI 1.

In addition to the functions of the first embodiment, the transmitter 2016 in the present embodiment transmits the registered determination history from the determination history database 173 to another HMI 1 of the distributed control system 100.

In the present embodiment, in response to an update of the determination number registered in the determination history database 173, the transmitter 2016 transmits the determination history to another HMI 1. However, the transmission timing of the transmitter 2016 is not limited thereto. For example, the transmitter 2016 may transmit the determination history to another HMI 1 at certain time intervals. For the transmission to another HMI 1 at certain time intervals, the transmitter 2016 may set, as a subject of transmission, the data registered in the determination history database 173 after a previous transmission, or all the data on the determination history of the operator of the corresponding HMI 1.

The following describes details of the determination history database 173 in accordance with the present embodiment.

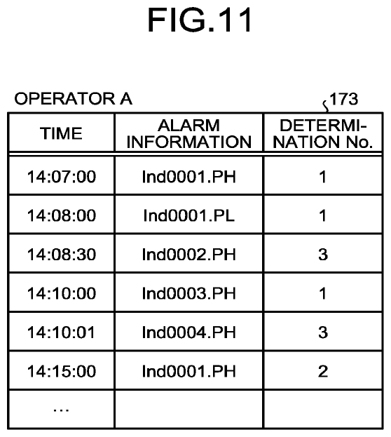

FIG. 11 is a chart illustrating an exemplary data configuration of the determination history database 173 of the present embodiment.

In the determination history database 173, the determination numbers of each operator, time at which the determination numbers have been inputted, and alarm information indicating alarms of interest are registered in association with one another. The determination history database 173 illustrated in FIG. 11 includes a determination history of the operator A. The determination history database 173 may be provided individually for the operators or the determination histories of the individual operators may be registered in different rows in the same determination history database 173.

The determination history database 173 stores previously registered determination numbers, so that a change history is added if the operator alters a determination number relative to the same alarm information in the determination history database 173. It also becomes possible to clarify when the determination number of each item of alarm information has been inputted, i.e., when the determination on each alarm has been made.

The following describes plant monitoring processing to be executed by the above-configured HMIs 1 in the present embodiment.

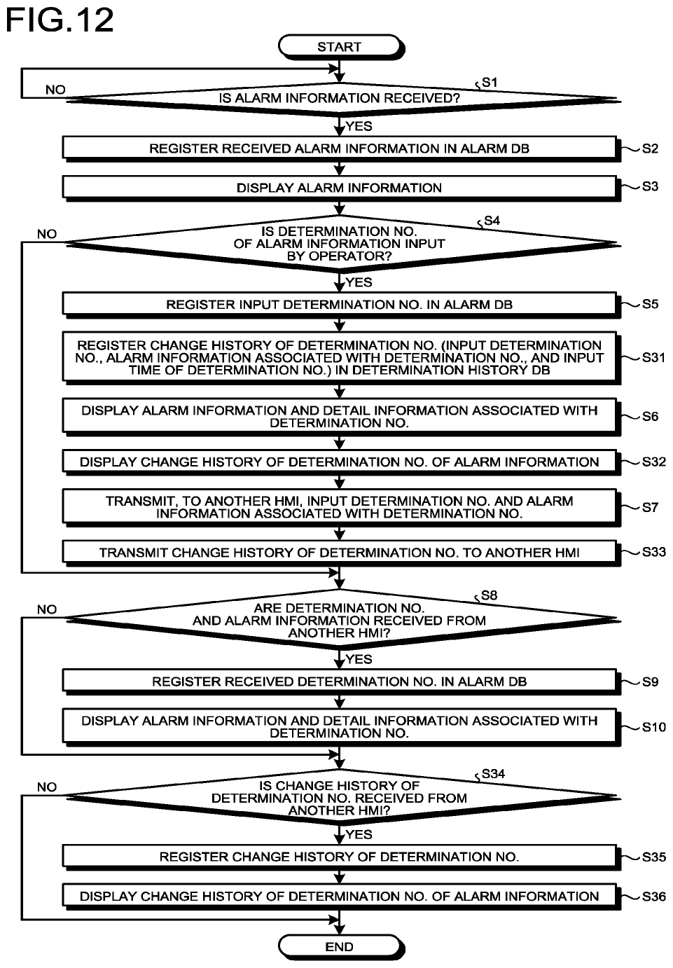

FIG. 12 is a flowchart illustrating exemplary plant monitoring processing executed by the HMI 1 of the present embodiment. The operation from the reception of alarm information at S1 to the registration of a determination number at S5 is the same as that in the first embodiment.

The register 2015 registers, in the determination history database 173, a change history of the determination number inputted by the operator at S4, i.e., an inputted determination number, alarm information corresponding to the determination number, and time at which the determination number has been inputted, in association with one another (S31).

The operation for displaying the alarm information and detail information at S6 is the same as that in the first embodiment.

Subsequently, the display controller 2011 reads the determination history database 173 to display the operator's change history of the determination numbers of the alarm information on the display 105 (S32).

The transmission of the determination number and the alarm information to another HMI 1 at S7 is the same as that in the first embodiment.

The transmitter 2016 transmits the change history of the determination numbers, inputted to the corresponding HMI 1 and registered in the determination history database 173, to another HMI 1 (S33).

The operation from the reception of a determination number and alarm information from another HMI 1 at S8 to the display of the alarm information and detail information at S10 is the same as that in the first embodiment.

When the second receiver 2014 receives, from another HMI 1, a change history of determination numbers inputted by another operator to another HMI 1 (inputted determination number, alarm information associated with the determination number, and time at which the determination number has been inputted) (“Yes” at S34), the register 2015a stores the received change history of determination numbers of another operator in the determination history database 173 (S35).

Subsequently, the display controller 2011 reads the determination history database 173 to display the change history of the determination numbers inputted to another HMI 1 on the display 105 in addition to the change history of the determination numbers of the alarm information inputted to the corresponding HMI 1 (S36).

When the second receiver 2014 receive no change history of the determination numbers from another HMI 1 (“No” at S34), the operations at S35 and at S36 are not executed, ending the processing of this flowchart.

As described above, the HMIs 1 in the present embodiment each include the determination history database 173 in which the change history of determination numbers of the alarm information is registered, and displays the change history of determination numbers on the display 105. In addition to the effects of the first embodiment, the HMIs 1 in the present embodiment enable the operators to easily know the history of changes to the determinations of the other operators about the alarm information. For example, the operators can know not only the latest determinations as of now but also the other operators' previous determinations, so as to be able to easily infer how the other operators have dealt with or considered the alarms to reach their current determinations. This makes it easier for the operators to work on the task in cooperation.

The HMIs 1 of the present embodiment can clearly present the time at which determination numbers have been inputted for each item of alarm information, which is useful for the operators to recheck previous alarms found by the other operators or determine necessity for assistance.

The present embodiment additionally includes the determination history database 173 with respect to the configuration of the first embodiment. Alternatively, the determination history database 173 may be added to the configuration of the second embodiment.

As described above, the HMIs 1 according to the first to the third embodiments make it possible for two or more operators to easily work on the task in cooperation.

The plant monitoring program executed by the HMIs 1 in each of the first to the third embodiments is recorded and provided in an installable or executable file format on a computer-readable storage medium such as a compact disc read only memory (CD-ROM), a flexible disk (FD), a compact disc recordable (CD-R), and a digital versatile disc (DVD).

The plant monitoring program executed by the HMIs 1 in each of the first to the third embodiments may be stored in a computer connected to a network such as the Internet and be downloaded and provided through the network. The plant monitoring program executed by the HMIs 1 in each of the embodiments may be provided or distributed through a network such as the Internet. The plant monitoring program in each of the first to the third embodiments may be incorporated and provided in a ROM.

The plant monitoring program executed by the HMIs 1 in each of the first to the third embodiments has a module configuration including the respective elements (display controller, accepter, first receiver, second receiver, register, and transmitter). As actual hardware, the CPU (processor) reads and executes the plant monitoring program from the above storage medium so as to load the respective elements on a main storage and generate the display controller, the accepter, the first receiver, the second receiver, the register, and the transmitter on the main storage.

Programs executed by the controllers 2 in each of the first to the third embodiments are recorded and provided in an installable or executable file format on a computer-readable recording medium such as a CD-ROM, a FD, a CD-R, and a DVD.

Furthermore, the programs executed by the controllers 2 in each of the first to the third embodiments may be stored in a computer connected to a network such as the Internet and be downloaded and provided through the network. The computer programs executed by the controllers 2 in each of the embodiments may be provided or distributed through a network such as the Internet.

The programs executed by the controllers 2 in each of the first to the third embodiments has a module configuration including the transmitter described above. As actual hardware, the CPU (processor) reads and executes the programs from the ROM so as to load the respective elements on a main storage and generate the transmitter on the main storage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1-6. (canceled)

7. A plant monitoring device, comprising:
a storage comprising an alarm database in which a plurality of items of determination information as to alarm information is registrable, the alarm information being identification information for identifying an alarm; and
one or more processors configured to register, in response to input of an item of determination information as to the alarm information, the item of determination information and the alarm information in the alarm database in association with each other.

8. The plant monitoring device according to claim 7, wherein
the storage further comprises a determination database that contains the item of determination information, detail information, and a display mode in association with one another, the detail information representing details of the item of determination information, and
the processors display, on a display, the alarm information registered in the alarm database and the detail information associated with the item of determination information corresponding to the alarm information, in the display mode associated with the item of determination information corresponding to the alarm information in the determination database.

9. The plant monitoring device according to claim 8, wherein the processors register:
the inputted determination information, detail information, and display mode in the determination database in association with one another, in response to input of the item of determination information, the detail information, and the display mode, and
the received determination information, detail information, and display mode in the determination database in association with one another, in response to receipt of the item of determination information, the detail information, and the display mode from another plant monitoring device.

10. The plant monitoring device according to claim 8, wherein
the storage further comprises a determination history database that contains the alarm information and time at which each of the items of determination information as to the alarm information has been inputted, in association with each other, and
the processors display, on the display, a change history of the item of determination information as to the alarm information.

11. The plant monitoring device according to claim 7, wherein
the alarm information represents tag data that indicates a kind of the alarm and an operation in which the alarm occurs.

12. A distributed control system comprising:
a controller configured to control a plant; and
a plurality of plant monitoring devices communicably coupled to the controller, wherein
the controller comprises a transmitter configured to transmit alarm information to the plant monitoring devices, the alarm information being identification information for identifying an alarm, and
the plant monitoring devices each comprises:
a storage comprising an alarm database in which a plurality of items of determination information as to alarm information is registrable, the alarm information being identification information for identifying an alarm; and
one or more processors configured to register, in response to input of an item of determination information as to the alarm information, the item of determination information and the alarm information in the alarm database in association with each other.
